(19) United States
(12) Patent Application Publication
(10) Pub. No.: US 2004/0198466 A1
(43) Pub. Date: Oct. 7, 2004

(54) Telematics device and method of operation

(76) Inventors: James Walby, Delavan, WI (US); Nick J. Grivas, Harvard, IL (US); Mark Stavropoulos, Green Oaks, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/339,994

(22) Filed: Jan. 10, 2003

(51) Int. Cl. H04M 1/00; H04B 1/38

(52) U.S. Cl. 455/574; 455/557; 455/572; 455/556.1

(57) ABSTRACT

A method of operating a telematics device includes a control unit (106) communicating an ignition status (139) of a vehicle (103) to a wireless device (104). The wireless device detects the ignition status and determines if a low-power mode (109) is available. If the low-power mode is available, the wireless device can communicate a low-power mode available signal (204) to the control unit. Upon receipt of the low-power mode available signal, the control unit communicates a shutdown time (206) to the wireless device and enters a power-off status (105). The wireless device enters the low-power mode and monitors for a power-on condition (115).

### BACKGROUND OF THE INVENTION

One of the fastest growing markets for providing wireless services is known as “telematics” and entails delivering a wide spectrum of information via wireless links to vehicle-based subscribers. The information can originate from multiple sources, such as the Internet and other public, private, and/or government computer-based networks; wireless telecommunications such as cellular, Personal Communication Service (PCS), satellite, land-mobile, and the like. Telematics systems can also provide roadside assistance, emergency calling, remote-door unlocking, automatic collision notification, travel conditions, vehicle security, stolen vehicle recovery, remote vehicle diagnostics, and the like. In addition, telematics systems can integrate and control vehicle sub-systems such as automatic door locks, traction control systems, and the like.

In prior art telematics systems, a control unit and an embedded cellular phone are separate entities that work together to control the telematics system. The control unit provides the interface to the vehicle and the embedded cellular phone provides the cellular connection for contacting a call center. In these prior art systems, the call center can only contact the control unit by utilizing the embedded cellular phone.

One disadvantage of current telematics systems is that some call center services need to be available when the vehicle is off (unlock, theft tracking, and the like). But concerns about vehicle battery drain make it impossible to leave the control unit and embedded cellular phone powered up at all times when the vehicle is off. Prior art methods of solving this problem include using a real-time clock to periodically wake up the control unit, which in turn powers up the embedded cellular phone to provide the cellular interface needed. This has the disadvantage of the embedded cellular phone, and hence the telematics system, only being available to receive incoming messages at periodic intervals. This severely limits the usefulness of the telematics system.

It is desirable to extend the availability of the telematics system and at the same time reduce the overall power consumption of the telematics system, thus minimizing drain on the vehicle battery when the vehicle is off. Accordingly, there is a significant need for a telematics device and method that overcomes the deficiencies of the prior art outlined above.

### BRIEF DESCRIPTION OF THE DRAWINGS

Referring to the drawing:

FIG. 1 depicts a block diagram of a communications system in accordance with an embodiment of the invention;

FIG. 2 depicts a ladder diagram in accordance with an embodiment of the invention;

FIGS. 3 and 4 illustrate a flow diagram of a method of the invention in accordance with an embodiment of the invention; and

FIG. 5 illustrates a flow diagram of a method of the invention in accordance with another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical, electrical, or logical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

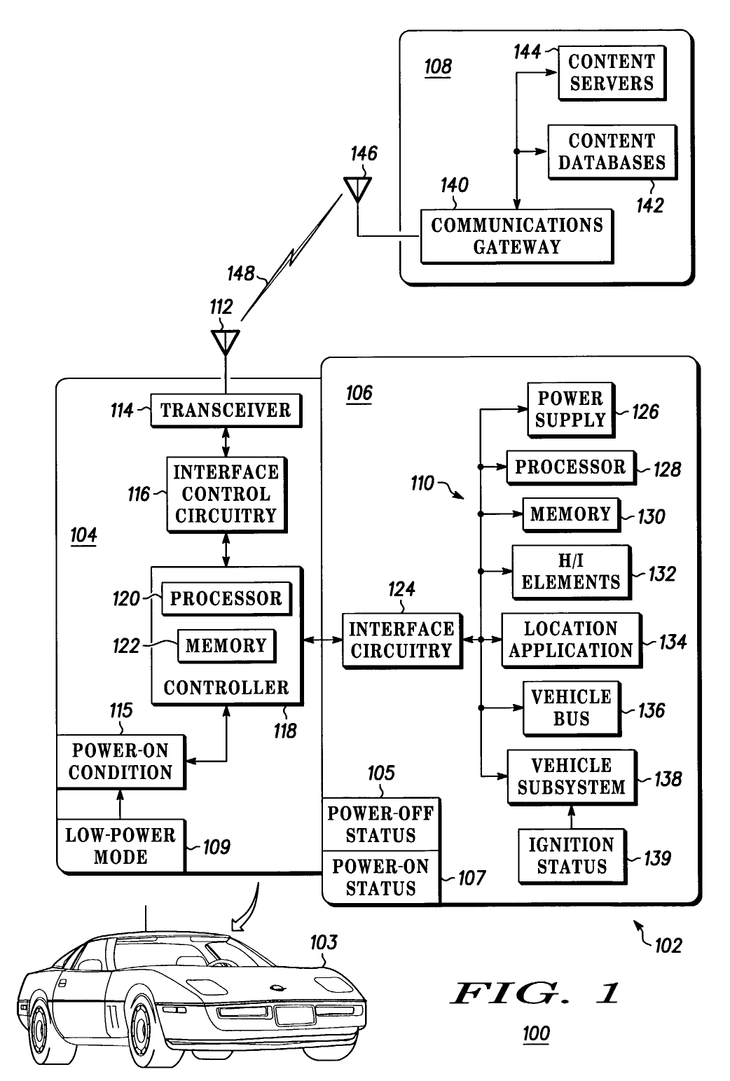

FIG. 1 depicts a block diagram of a communications system 100 in accordance with an embodiment of the invention. As shown in FIG. 1, communications system 100 includes telematics device 102 coupled to a vehicle 103. Telematics device 102 is coupled to communications node 108 via wireless link 148, where communications node 108 can be, for example, a call center, cellular network, and the like.

Communications node 108 can communicate with telematics device 102 and/or wireless device 104 via antenna 146, which is coupled to communications gateway 140. Communications gateway 140 can comprise one or more network access devices (NAD's) that can utilize narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. In another embodiment, communications gateway 140 can include messaging protocols such Short Message Service Cell Broadcast (SMSCB), General Packet Radio Service (GPRS), and the like.

Communications node 108 can include any number of local nodes (not shown for clarity), which function to relay wireless link 148 to telematics device 102. For example, communications node 108 can include local nodes that function as base stations in a cellular network. Communications node 108 can be coupled to public switched telecommunication network (PSTN), Internet, an integrated services digital network (ISDN), satellites, local area networks (LAN's), wide area networks (WAN's) other communications systems (not shown for clarity), and the like. Although only one communications node 108 and one telematics device 102 are shown as comprising communications system 100, the invention can include any number of these elements interoperating with each other.

Communications node 108 can include content servers 144 and content databases 142, which can include a hard drive, floppy disk drive, optical drive, CD-ROM, RAM, ROM, EEPROM, or any other means of storing content, which can be utilized by telematics device 102. As an example of an embodiment, content databases 142 function to store location information, user profiles, traffic content, map content, point-of-interest content, usage history, and the like. However content databases 142 are not limited to these functions, and other database functions are within the scope of the invention. As an example of an embodiment, content servers. 144 can include traffic servers, map servers, user profile servers, location information servers, and the like. However, content servers 144 are not limited to these functions, and other content server functions are within the scope of the invention.

In an embodiment, telematics device 102 is coupled to and integrated with vehicle l03, such as a car, truck, bus, and the like. Telematics device 102 can include, among other things, an integrated in-vehicle wireline and wireless communications system that operates to communicate content to and from vehicle through wireline and/or wireless means. In the embodiment show in FIG. 1, telematics device comprises wireless device 104 and control unit 106 coupled by wireline and/or wireless means. In one embodiment, wireless device 104 can be an embedded wireless device, which is an integral part of telematics device. In another embodiment wireless device 104 can be a portable wireless device, which is capable of operation independent of telematics device 102 or control unit 106, for example a cellular or Personal Communication Service (PCS) telephone, a pager, a hand-held computing device such as a personal digital assistant (PDA) or Web appliance, and the like.

In the embodiment shown, wireless device 104 includes antenna 112, which feeds transceiver 114 and interface control circuitry 116. Transceiver 114 is capable of sending and receiving content to and from communications node 108 via wireless link 148. In an embodiment, wireless link 148 can be an analog wireless communications signal and/or a digital wireless communications signal. Wireless link 148 can utilize a cellular network, paging network, satellite network, and the like. In an example of an embodiment, communication over wireless link 148 can include narrowband and/or broadband communications with standard cellular network protocols such as Advanced Mobile Phone Service (AMPS), Global System for Mobile Communications (GSM), Time Division Multiple Access (TDMA), Code Division Multiple Access (CDMA), and the like. In another embodiment, standard transmission control protocol/internet protocol (TCP/IP) can also be used. In another embodiment, communication over wireless link 148 can include messaging protocols such Short Message Service Cell Broadcast (SMSCB), General Packet Radio Service (GPRS), and the like. In still another embodiment, communication over wireless link 148 can include AM, FM bands, subcarriers, and the like.

In the embodiment depicted in FIG. 1, wireless device 104 includes controller 118, which controls I/O signals, communication interfaces, displays, and the like. Controller 118 can include a processor 120 for processing algorithms stored in memory 122. Memory 122 comprises control algorithms, and can include, but is not limited to, random access memory (RAM), read only memory (ROM), flash memory, electrically erasable programmable ROM (EEPROM), and the like. Memory 122 can contain stored instructions, tables, data, and the like, to be utilized by processor 120. Wireless device 104 can contain its own power source (not shown) or use power supply 126 in control unit 106, or a power supply in vehicle 103.

In an embodiment, wireless device 104 can function in three different power modes: power-off, power-on and low-power mode 109. In power-off mode, wireless device 104 does not send or receive wireless communication over wireless link 148. In power-on mode, wireless device 104 is capable of both sending and receiving wireless communication over wireless link 148. In low-power mode 109 (discussed more fully below), wireless device 104 can receive wireless communication but not send (transmit) over wireless link 148. In low-power mode 109, wireless device 104 consumes significantly less power than in power-on mode. When in low-power mode 109, wireless device 104 can monitor for a power-on condition 115 for control unit 106 (discussed more fully below).

As shown in FIG. 1, control unit 106 can include interface circuitry 124 to interface with wireless device 104. In one embodiment, interface circuitry 124 controls the interface with an embedded wireless device. In another embodiment, interface circuitry 124 controls the interface with a portable wireless device, where the interface can include, docking status, and the like.

In an embodiment, interface circuitry 124 is coupled to various control unit resources 110. Control unit resources 110 can include power supply 126, which can be a self-contained power supply or the power supply utilized by vehicle 103, such as a battery, and the like. Control unit resources 110 can also include a processor 128 for processing algorithms stored in memory 130. Memory 130 comprises control algorithms, and can include, but is not limited to, random access memory (RAM), read only memory (ROM), flash memory, electrically erasable programmable ROM (EEPROM), and the like. Memory 130 can contain stored instructions, tables, data, and the like, to be utilized by processor 128.

Control unit resources 110 can also include human interface (H/I) elements 132, which can comprise elements such as a display, a multi-position controller, one or more control knobs, one or more indicators such as bulbs or light emitting diodes (LEDs), one or more control buttons, one or more speakers, a microphone, and any other H/I elements required by wireless device. H/I elements 132 can request and display content and data including, application data, position data, personal data, email, audio/video, and the like. The invention is not limited by the (H/I) elements described above. As those skilled in the art will appreciate, the (H/I) elements outlined above are meant to be representative and to not reflect all possible (H/I) elements that may be employed.

Optionally, control unit resources 110 can include location application 134. Location application 134 can be coupled to and/or include, any number of position sources, devices and software elements designed to determine a position of telematics device 102 and associated vehicle 103. Examples of sources and devices, without limitation, include global positioning system (GPS), differential GPS, a kiosk (fixed position source), and enhanced observed time difference (EOTD), which comprise terrestrial cellular triangulation, and the like. Other navigational position sources and software can include, without limitation, an airspeed device, Doppler device, inclinometer, accelerometer, speedometer, compass, gyroscope altimeter, network-assisted GPS, differential GPS, any combination of optical transmitters, receivers, reflectors, optically readable tag, gyro, and the like.

Control unit 106 can be coupled to, and control unit resources 110 can include, vehicle bus 136 and vehicle subsystem 138. Vehicle bus 136 can include both vehicle electrical bus and a vehicle data bus. Vehicle subsystem 138 can include for example and without limitation, ignition system, door-locking system, comfort features such as seat and mirror adjustments, climate control, automatic distress system, security system, antenna(s), and the like.

Control unit 106 can communicate with, exchange data with and utilize one or more control unit resources 110, including vehicle bus 136 and one or more vehicle subsystems 138. Communicating with can include, without limitation, accessing, operating, configuring, controlling, streaming media to and from, voice communication, downloading or uploading software, communicating status, and the like. Control unit 106 can access the status of any of control unit resources 110 and vehicle subsystems 138, for example, ignition status 139, security status, engine status, internal climate status, occupancy detection system, change in vehicle position (delta-GPS) system, and the like. In one embodiment, control unit 106 allows wireless device 104 to exchange data with including access, operate, control and configure any of the control unit resources 110.

Ignition status 139 can include an ignition off status indicating that the vehicle 103 engine is shut-off and the ignition switch is in the off position. In this instance, any power consumed by telematics device 102 can be drawn only from the vehicle battery, power supply 126, other finite source, and the like. In this configuration, an ignition off status can be sent from control unit 106 to wireless device 104. Ignition status 139 can also include ignition on status, which indicates that the vehicle 103 engine is operating and providing a power source to telematics device 102 other than the finite source of a battery. In this configuration, an ignition on status can be sent from control unit 106 to wireless device 104.

Control unit 106 can operate in two power modes: power-off status 105 and power-on status 107. In power-off status 105, control unit 106 consumes little or no power and is essentially in a sleep mode. In power-on status 107, control unit 106 can operate control unit resources 110 and send and receive messages from wireless device 104 and control unit resources 110, including vehicle bus 136 and any of vehicle subsystems 138.

In an embodiment, when wireless device 104 receives an ignition off status from control unit 106, wireless device 104 determines if it can enter low-power mode 109. In an embodiment, low-power mode can be entered by wireless device 104 when a digital wireless communication signal 148 is available to wireless device 104. This allows wireless device 104 to utilize a discontinuous receive (DRX) feature that allows wireless device 104, on its own without the assistance of control unit 106, to periodically check and see if an attempt is being made by, for example, communications node 108 to contact wireless device 104. The DRX feature is not available where only an analog wireless communication signal is available. If wireless device 104 is able to enter low-power mode 109, control unit 106 can communicate to wireless device 104 a shutdown time in which wireless device 104 is to remain in low-power mode 109, and subsequently, control unit 106 can enter power-off status and wait for a power-on condition 115 to be received from wireless device 104.

This configuration has the advantage of conserving power since wireless device 104 operating in low-power mode 109 consumes significantly less power than if control unit is in power-on status 107. Also, wireless device 104 in low-power mode 109 and control unit in power-off status 105 consumes significantly less power than if control unit periodically powering-on wireless device 104 to check for incoming communications as is done in the prior art. If only an analog wireless communication signal is available, wireless device 104 lets control unit 106 know that low-power mode 109 is not available and control unit 106 can then revert to the prior art method of powering-on wireless device 104 at a periodic interval.

When wireless device 104 is in low-power mode 109 and control unit 106 is in power-off status 105, a power-on condition 115 can occur where it is required that control unit 106 return to power-on status 107. In an embodiment, wireless device 104 monitors for power-on condition 115 while control unit 106 is in power-off status and without instructions from control unit 106. As an example, a power-on condition 115 can occur where there is a request for one or more control unit resources 110, such as an incoming wireless communication over wireless link 148 from communications node 108. This can be, for example and without limitation, an incoming SMS message, request for vehicle location, ignition status, door lock/unlock, security status, and the like. Another example of power-on condition 115 can be that wireless device 104 can no longer receive digital wireless communication signal 148 and can therefore no longer remain in low-power mode 109 without exceeding a predetermined power budget. In this instance, wireless device 104 can “wake up” control unit 106 so control unit 106 can implement a periodic powering scheme for wireless device for the remainder of shutdown time.

In another embodiment, control unit 106 can receive a power-on condition 115 independent of wireless device 104 and enter power-on status 107, thereby bypassing wireless device 104. This can occur, for example, where there is activity on vehicle bus 136 such as a security system alert, and the like, that does not go through wireless device 104.

Software blocks that perform embodiments of the invention are part of computer program modules comprising computer instructions, such as control algorithms, that are stored in a computer-readable medium such as memory described above. Computer instructions can instruct processors to perform methods of operating a telematics device 102. In other embodiments, additional modules could be provided as needed. The elements shown in telematics device 102 and communications node 108 are exemplary and not limiting of the invention. Other hardware and software blocks can also be included in telematics device 102 and communications node 108 and are also within the scope of the invention.

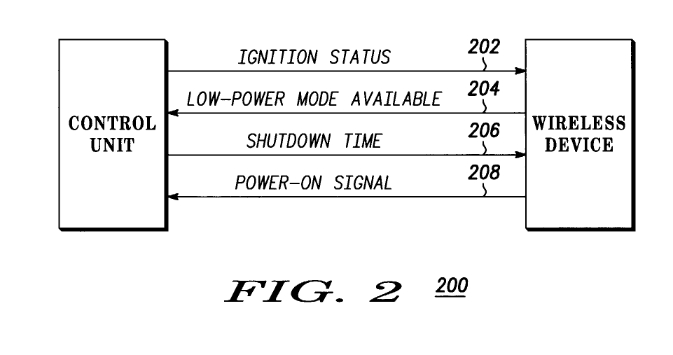

FIG. 2 depicts a ladder diagram 200 in accordance with an embodiment of the invention. As shown in FIG. 2, control unit 106 communicates an ignition status 202 to wireless device 104. Ignition status 202 can be either an ignition off status or an ignition on status as described above. Wireless device 104 then determines if low-power mode 109 is available, and if so, wireless device 104 communicates low-power mode available signal 204 to control unit 106. Control unit 106 then communicates shutdown time 206 to wireless device 104 indicating the amount of time that wireless device 104 is to stay in low-power mode 109. Subsequently, control unit 106 enters power-off status 105 and wireless device 104 enters low-power mode 109. While in low-power mode 109, wireless device 104 monitors for a power-on condition 115. Upon receipt of power-on condition 115, wireless device 104 communicates power-on signal 208 to control unit 106 and control unit 106 enters power-on status 107. Once in power-on status 107, control unit 106 can then process the request that initiated the power-on condition 115, such as processing a paging message, vehicle bus 136 activity, and the like.

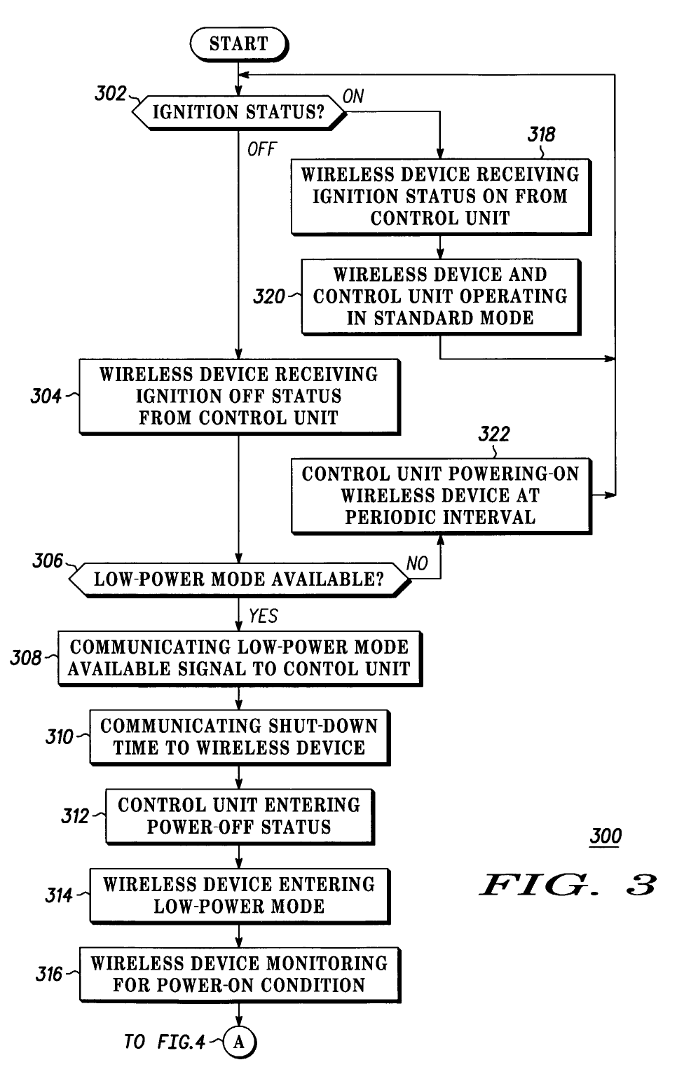

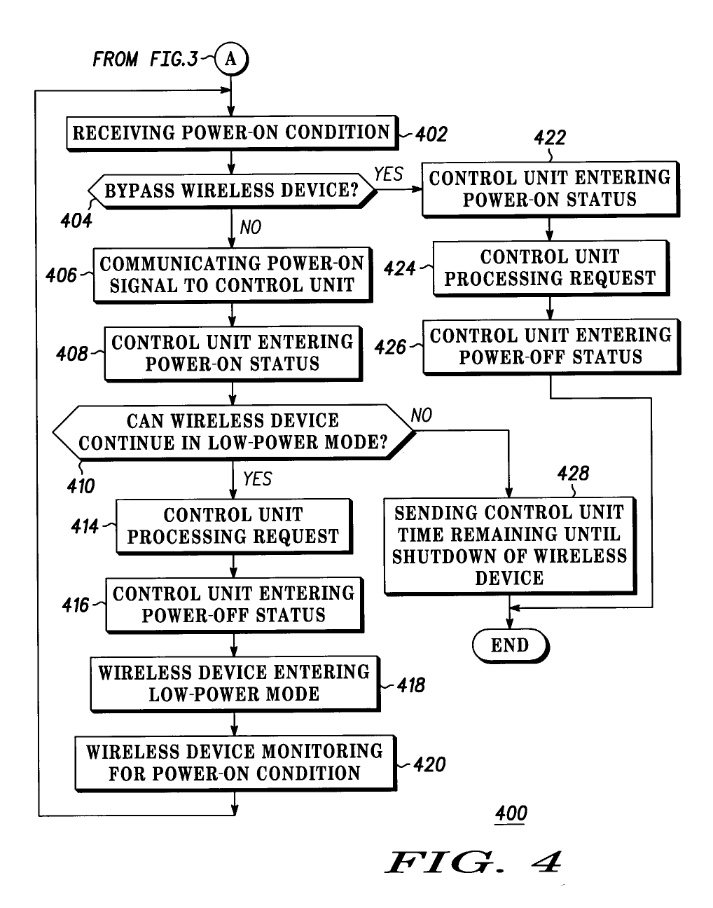

FIGS. 3 and 4 illustrate a flow diagram 300, 400 of a method of the invention in accordance with an embodiment of the invention. In step 302, control unit 106 determines ignition status 139. If ignition status is “on,” then wireless device 104 receives ignition on status from control unit 106 per step 318. In step 320, wireless device 104 and control unit 106 then both operate in a standard mode where control unit is in power-on status 107 and wireless device 104 is powered up. Since the ignition is on, power budgeting is not an issue and both control unit 106 and wireless device 104 can be powered up and fully operational.

If control unit 106 determines ignition status 139 is “off” in step 302, then wireless device 104 receives ignition off status from control unit 106 in step 304. In step 306 it is determined if low-power mode 109 is available. If not, control unit 106 powers-on wireless device at periodic intervals to check for any incoming messages as is done the prior art per step 322. If low-power mode 109 is available in step 306, wireless device communicates low-power mode available signal 204 to control unit 106 per step 308. Control unit 106 then communicates shutdown time 206 to wireless device 104 per step 310, where shutdown time 206 can be preprogrammed into control unit 106, user defined, and the like. In step 312, control unit 106 enters power-off status 105, and in step 314 wireless device 104 enters low-power mode 109. In step 316, wireless device 104 monitors for power-on condition 115.

Moving on to FIG. 4 via the “A” bubble, in step 402, wireless device 104 receives a power-on condition 115. Power-on condition 115 can be any condition that requires the use of control unit resources 110 as described above. In step 404, it is determined if the power-on condition 115 bypasses wireless device 104. If so, the power-on condition 115 can originate from vehicle bus 136 or vehicle subsystems 138, and the control unit 106 enters power-on status 107, bypassing wireless device 104 in step 422. In step 424 control unit 106 processes the request, for example, a vehicle security alert, such as an attempt at theft, and the like. In step 426, control unit 106 can enter power-off status 105. In another embodiment, control unit 106 can power-on wireless device 104 in step 426.

If power-on condition 115 is coming through wireless device 104 (not bypassing) in step 404, in step 406 wireless device communicates power-on signal 208 to control unit 106. In step 408, control unit enters power-on status 107. In step 410, it is determined if wireless device 104 can continue in low-power mode 109. This determination by wireless device 104 can be made based on a preprogrammed power budget, determining the amount of power remaining in a power source, such as power supply 126, car battery, and the like. If wireless device 104 cannot remain in low-power mode 109 for the remainder of shutdown time 206, then wireless device 104 sends control unit 106 the time remaining until wireless device 104 enters its power-off mode and shuts down per step 428.

If wireless device 104 can remain in low-power mode 109 for remainder of shutdown time 206 per step 410, then in step 414 control unit 106 processes the request that generated the power-on condition 115. Subsequently to processing the request, in step 416, control unit 106 again enters power-off status 105, and in step 418 wireless device 104 re-enters low-power mode 109. In step 420, wireless device 104 returns to monitoring for power-on condition 115.

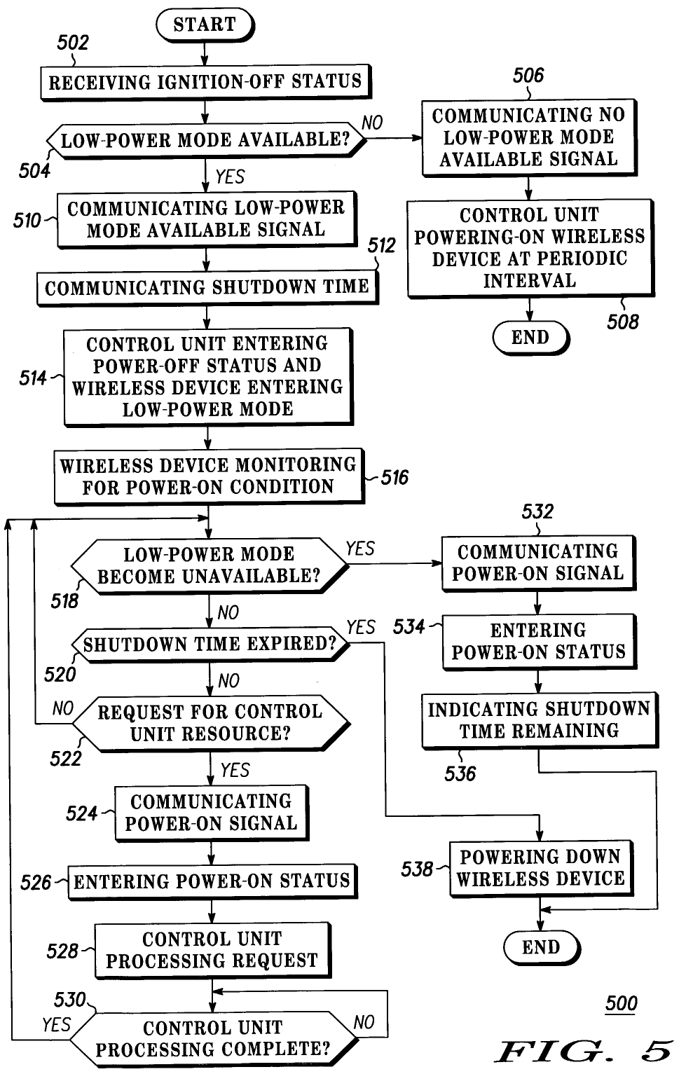

FIG. 5 illustrates a flow diagram 500 of a method of the invention in accordance with another embodiment of the invention. In step 502, wireless device 104 receives ignition off status from control unit 106. In step 504, it is determined if low-power mode 109 is available. If not, wireless device 104 communicates a no low-power mode available signal to control unit 106 in step 506. In step 508, control unit 106 powers-on wireless device 104 at periodic intervals to check for incoming messages.

If low-power mode 109 is available in step 504, then low-power mode available signal 204 is communicated to control unit 106 per step 510. In step 512, control unit 106 communicates shutdown time 206 to wireless device 104. In step 514, control unit 106 enters power-off status 105 and wireless device 104 enters low-power mode 109, and in step 516 wireless device monitors for power-on condition 115.

In step 518, it is determined if low-power mode 109 has become unavailable. This can occur if wireless device moves out of range of digital wireless communication signal 148 or digital wireless communication signal 148 otherwise becomes unavailable to wireless device 104. If so, wireless device 104 communicates power-on signal 208 to control unit 106 in step 532 and control unit 104 enters power-on status 107 in step 534. In step 536, wireless device 104 indicates to control unit 106 amount of time remaining until shutdown of wireless device 104. Time remaining can be determined by wireless device 104 or control unit 106 based on a preprogrammed power budget, a user defined power budget, power remaining status of a power source, and the like.

If low-power mode 109 has not become unavailable in step 518, it is then determined if shutdown time 206 has expired in step 520. If so, wireless device 104 powers down per step 538. Subsequently, wireless device 104 and control unit 106 are both off and can await an ignition on status before powering back up. If shutdown time 206 has not expired in step. 520, it is then determined if there is a request for control unit resources 110 in step 522. If not, the process returns to step 518. If there has been a request for control unit resources 110, then wireless device 104 communicates power-on signal 208 per step 524, and control unit 106 enters power-on status 107 per step 526. Control unit 106 processes the request in step 528. In step 530, it is determined if the processing of the request for control unit resources 110 is complete. If not, control unit 106 continues to process the request. If, completed, control unit 106 can re-enter power-off status 105 and the process returns to step 518.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A method of operating a telematics device, comprising:
a control unit communicating an ignition status of a vehicle to a wireless device
the wireless device detecting the ignition status;
the wireless device determining if a low-power mode is available;
if the low-power mode is available, the wireless device communicating a low-power mode available signal to the control unit;
upon receipt of the low-power mode available signal, the control unit communicating a shutdown time to the wireless device;
the control unit entering a power-off status;
the wireless device entering the low-power mode; and
the wireless device monitoring for a power-on condition.

2. The method of claim 1, if the low-power mode is unavailable, the control unit powering-on the wireless device at a periodic interval.

3. The method of claim 1, wherein the power-on condition comprises receiving a request for a control unit resource.

4. The method of claim 1, wherein the power-on condition comprises the shutdown time expiring.

5. The method of claim 1, wherein the power-on condition comprises the low-power mode becoming unavailable.

6. The method of claim 1, wherein the low-power mode is available to the wireless device when a digital wireless communication signal is available to the wireless device.

7. The method of claim 1, further comprising upon receipt of the power-on condition, the wireless device communicating a power-on signal to the control unit, and wherein the control unit enters a power-on status.

8. The method of claim 1, wherein the wireless device is an embedded wireless device.

9. The method of claim 1, wherein the wireless device is a portable wireless device.

10. The method of claim 1, further comprising the control unit receiving a request for a control unit resource, wherein the request for the control unit resource bypasses the wireless device, and wherein the control unit enters a power-on status independent of the wireless device.

11. In a wireless device, a method of operating a telematics device, comprising:
receiving an ignition off status from a control unit;
determining if a low-power mode is available;
if the low-power mode is available, the wireless device communicating a low-power mode available signal to the control unit;
receiving a shutdown time from the control unit;
entering the low-power mode; and
monitoring for a power-on condition.

12. The method of claim 11, wherein the low-power mode is available to the wireless device when a digital wireless communication signal is available to the wireless device.

13. The method of claim 11, further comprising upon receipt of the power-on condition, the wireless device communicating a power-on signal to the control unit.

14. In a control unit, a method of operating a telematics device, comprising:
communicating an ignition off status to a wireless device;
receiving a low-power mode available signal from the wireless device;
communicating a shutdown time to the wireless device;
entering a power-off status; and
entering a power-on status upon receipt of a power-on condition from the wireless device.

15. The method of claim 14, if the low-power mode is unavailable, the control unit powering-on the wireless device at a periodic interval.

16. The method of claim 14, further comprising receiving a request for a control unit resource, wherein the request for the control unit resource bypasses the wireless device, and wherein the control unit enters the power-on status independent of the wireless device.

17. A method of operating a vehicle, comprising:
a control unit communicating an ignition status of the vehicle to a wireless device
the wireless device detecting the ignition status;
if the ignition status is an ignition off status, the wireless device determining if a low-power mode is available;
if the low-power mode is available, the wireless device communicating a low-power mode available signal to the control unit;
upon receipt of the low-power mode available signal, the control unit communicating a shutdown time to the wireless device;
the control unit entering a power-off status;
the wireless device entering the low-power mode; and
the wireless device monitoring for a power-on condition.

18. The method of claim 17, if the low-power mode is unavailable, the control unit powering-on the wireless device at a periodic interval.

19. The method of claim 17, wherein the power-on condition comprises receiving a request for a control unit resource.

20. The method of claim 17, wherein the power-on condition comprises the shutdown time expiring.

21. The method of claim 17, wherein the power-on condition comprises the low-power mode becoming unavailable.

22. The method of claim 17, wherein the low-power mode is available to the wireless device when a digital wireless communication signal is available to the wireless device.

23. The method of claim 17, further comprising upon receipt of the power-on condition, the wireless device communicating a power-on signal to the control unit, and wherein the control unit enters a power-on status.

24. The method of claim 17, further comprising the control unit receiving a request for a control unit resource, wherein the request for the control unit resource bypasses the wireless device, and wherein the control unit enters a power-on status independent of the wireless device.

25. A telematics device, comprising:
a control unit coupled to communicate an ignition off status of a vehicle; and
a wireless device coupled to receive the ignition off status of the vehicle from the control unit, wherein the wireless device determines if a low-power model is available, wherein the wireless device communicates a low-power mode available signal to the control unit, wherein the wireless device enters the low-power mode, and wherein the wireless device monitors for a power-on condition, and wherein upon receipt of the power-on condition, the wireless device communicates a power-on signal to the control unit.

26. The device of claim 25, wherein the power-on condition comprises a request for a control unit resource.

27. The device of claim 25, wherein the power-on condition comprises expiration of a shutdown time.

28. The device of claim 25, wherein the power-on condition comprises the low-power mode becoming unavailable.

29. The device of claim 25, wherein the low-power mode is available to the wireless device when a digital wireless communication signal is available to the wireless device.

30. The device of claim 25, wherein the wireless device is an embedded wireless device.

31. The device of claim 25, wherein the wireless device is a portable wireless device.

32. A vehicle, comprising:
a control unit coupled to communicate an ignition off status of a vehicle; and
a wireless device coupled to receive the ignition off status of the vehicle from the control unit, wherein the wireless device determines if a low-power mode is available, wherein the wireless device communicates a low-power mode available signal to the control unit, wherein the wireless device enters the low-power mode, and wherein the wireless device monitors for a power-on condition, and wherein upon receipt of the power-on condition, the wireless device communicates a power-on signal to the control unit.

33. The vehicle of claim 32, wherein the power-on condition comprises a request for a control unit resource.

34. The vehicle of claim 32, wherein the power-on condition comprises expiration of a shutdown time.

35. The vehicle of claim 32, wherein the power-on condition comprises the low-power mode becoming unavailable.

36. The vehicle of claim 32, wherein the low-power mode is available to the wireless device when a digital wireless communication signal is available to the wireless device.

37. The vehicle of claim 32, wherein the wireless device is an embedded wireless device.

38. The vehicle of claim 32, wherein the wireless device is a portable wireless device.

39. A computer-readable medium containing computer instructions for instructing a processor to perform a method of operating a telematics device, the instructions comprising:
a control unit communicating an ignition status of the vehicle to a wireless device
the wireless device detecting the ignition status;
if the ignition status is an ignition off status, the wireless device determining if a low-power mode is available;
if the low-power mode is available, the wireless device communicating a low-power mode available signal to the control unit;
upon receipt of the low-power mode available signal, the control unit communicating a shutdown time to the wireless device;
the control unit entering a power-off status;
the wireless device entering the low-power mode; and
the wireless device monitoring for a power-on condition.

40. The computer-readable medium of claim 39, if the low-power mode is unavailable, the control unit powering-on the wireless device at a periodic interval.

41. The computer-readable medium of claim 39, further comprising upon receipt of the power-on condition, the wireless device communicating a power-on signal to the control unit, and wherein the control unit enters a power-on status.

42. The method of claim 39, further comprising the control unit receiving a request for a control unit resource, wherein the request for the control unit resource bypasses the wireless device, and wherein the control unit enters a power-on status independent of the wireless device.

43. A computer-readable medium containing computer instructions for instructing a processor to perform in a wireless device, a method of operating a telematics device, the instructions comprising:
receiving an ignition off signal from a control unit;
determining if a low-power mode is available;
if the low-power mode is available, the wireless device communicating a low-power mode available signal to the control unit;
receiving a shutdown time from the control unit;
entering the low-power mode; and
monitoring for a power-on condition.

44. A computer-readable medium containing computer instructions for instructing a processor to perform in a control unit, a method of operating a telematics device, the instructions comprising:
communicating an ignition off status to a wireless device;
receiving a low-power mode available signal from the wireless device;
communicating a shutdown time to the wireless device;
entering a power-off status; and
entering a power-on status upon receipt of a power-on condition from the wireless device.
